(19) United States
(12) Patent Application Publication
(10) Pub. No.: US 2017/0099364 A1
(43) Pub. Date: Apr. 6, 2017

(54) SYSTEM AND METHOD FOR IMPARTING LEARNING CONTENTS VIA A NETWORK

(71) Applicant: ZEREBRAS GMBH, Bocholt (DE)

(72) Inventors: Simon BÖING-MESSING, Bocholt (DE); Martin BÖING-MESSING, Bocholt (DE)

(21) Appl. No.: 15/126,939

(22) PCT Filed: Mar. 16, 2015
(86) PCT No.: PCT/EP2015/055467

§ 371 Date: Sep. 16, 2016

(30) Foreign Application Priority Data
Mar. 17, 2014 (DE) 10 2014 103 634.4

(51) Int. Cl. H04L 29/08; A63F 13/35

(52) U.S. Cl. CPC H04L 67/26; A63F 13/35; H04L 67/42

(57) ABSTRACT

The present invention relates to a system and method for imparting learning contents and/or knowledge via a network. The invention further relates to a method for furnishing services for the purpose of imparting knowledge.

The present invention relates to a system and a network-based method for the transfer of learning contents and/or knowledge. In addition, the invention relates to a method for the transfer of services for the transfer of knowledge.

The transfer of services over the internet becomes increasingly popular. Herein, the transfer of services over the internet offers advantages both for the imparter of knowledge and for the receiver of knowledge. The imparter of knowledge via the internet reaches a much larger group of receivers of knowledge than he could reach through a local offer. Basically the imparter of knowledge by offering services over the internet is enabled to establish a world-wide representation with a single distribution site and thus to address a world-wide group of receivers of knowledge. The receiver of knowledge has the advantage that he has access to a very extensive range of services independently from his residence or location. In addition, this will enable him to compare directly the offers of different providers in a simple manner, without requiring to actually visit the imparters of knowledge on site.

By determining the user behavior on the platform and by data from third-party internet applications services and products are transferred to the user in a targeted manner and a total learning experience by means of gamification for avoiding intrinsic motivation loss is offered to him. The term gamification means the application of elements and processes typically found in games within context that has nothing to do with games. These elements typically found in games include inter alia experience points, high scores, progress bars, ranking lists, virtual goods or awards. By integrating these playful elements an increase of motivation of people should be achieved who otherwise have to perform less challenging tasks or tasks perceived as too monotonous or too complex.

In particular, by means of the invention the transfer is optimized by taking account an optimum booking utilization, which leads to a higher efficiency at the imparter of knowledge and to lower costs at the receiver of knowledge. By supplementing the provision of the services with various functionalities and additional information a clear differentiation from other providers is achieved.

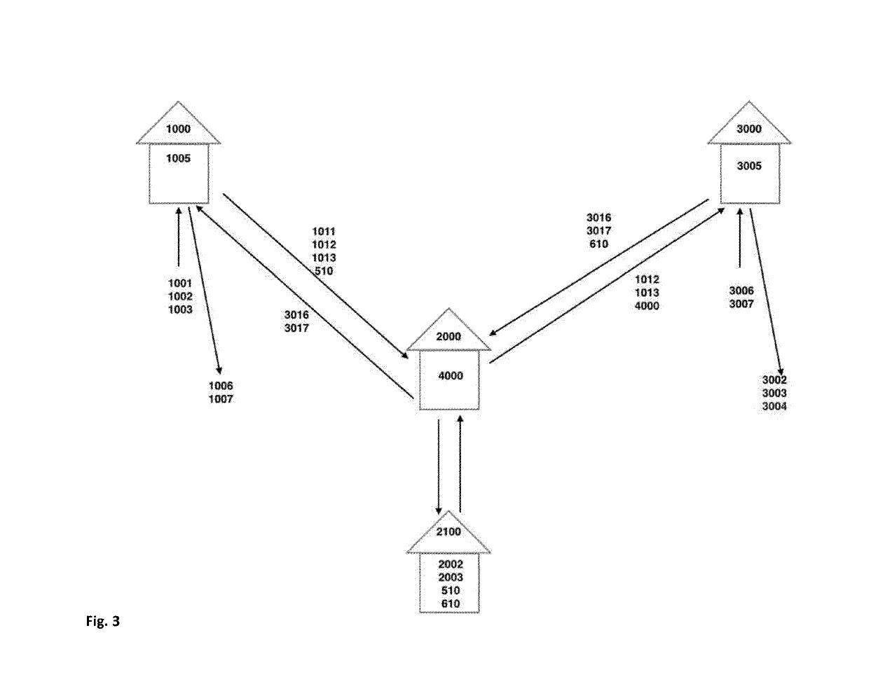

FIG. 3 shows a schematic flow of an exemplary embodiment of a method according to the invention.

By means of the invention a network-based system for the transfer of knowledge content is provided, comprising
a first client (1000);
a server (2000):
a second client (3000), wherein the first client (1000) and the second client (3000) are communicatively connected to the server (2000) via a packet-switched network system;
means (1001, 1002, 1003) for detecting a motion, audio and/or video signal (1011, 1012, 1013), wherein the means is signally connected to the first client (1000);
means for outputting an audio and/or video signal (1006, 1007), wherein the means is signally connected to the first client (1000);
means for outputting an audio and/or video signal (3002, 3003), wherein the means is signally connected to the second client (3000);
means (3004) for outputting an analysis signal (4000), wherein the means is signally connected to the second client (2000),
wherein said method is characterized in that the server (2000) is adapted to receive information on a motion, audio, and/or video signal (1011, 1012, 1013) detected by the means (1002 and/or 1003) from the first client (1000) via the packet-switched network, to collate the received signal with a template (2002) stored in a database system (2100) connected to the server (2000), and to transmit the received motion, audio, and/or video signal together with information on the deviation of the received signal from the stored template (2002) as an analysis signal (4000) over a packet-switching network to the second client (3000), and wherein the second client (3000) is adapted to output the audio and/or video signal received from the server (2000) via the means (3002, 3003) together with the analysis signal (4000) via the means (3004).

In a preferred embodiment of the network-based system the means (1001) for detecting a motion signal (1011) comprises a means attachable to the human body or to a means operated by the human body which at least comprises an inertial sensor and a communication interface for transmitting the inertial sensor signals to the first client (1000).

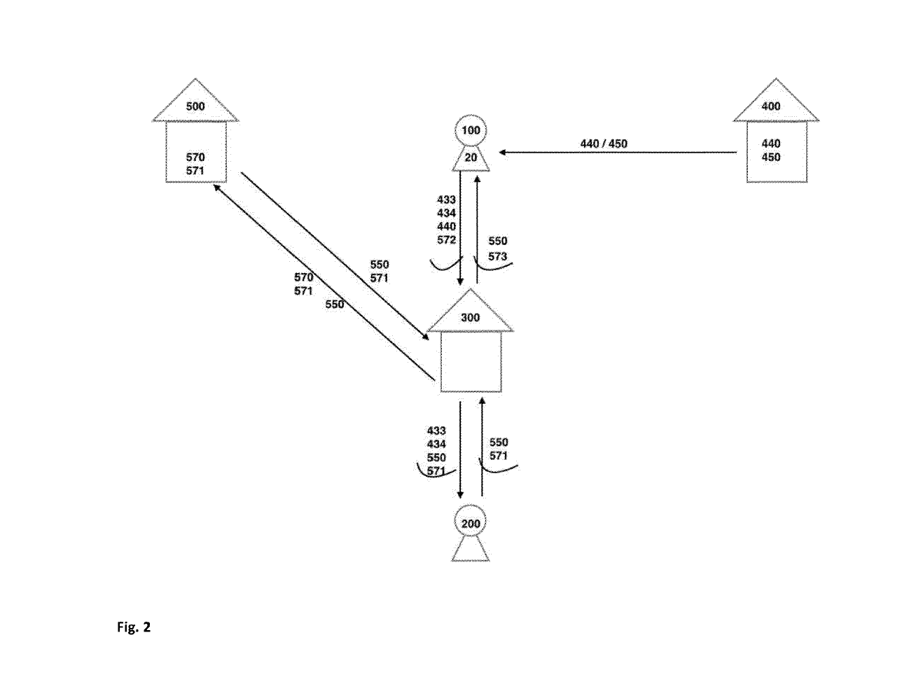

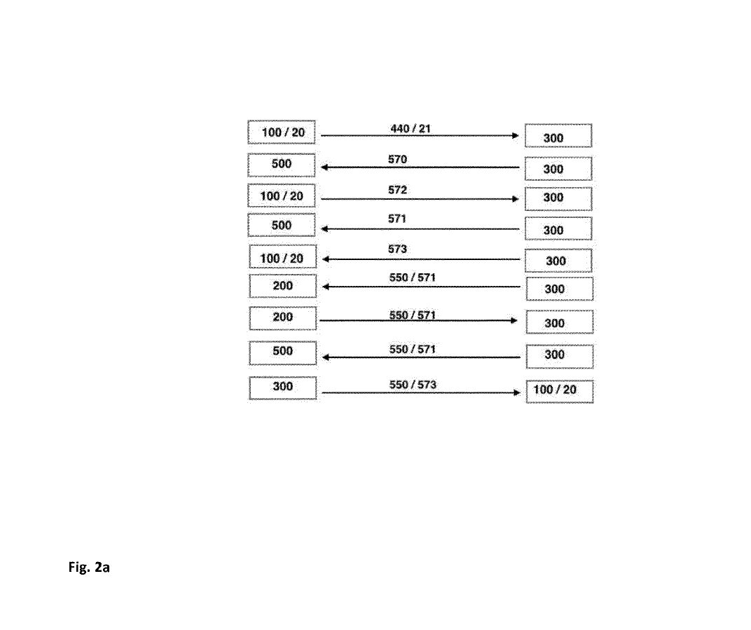

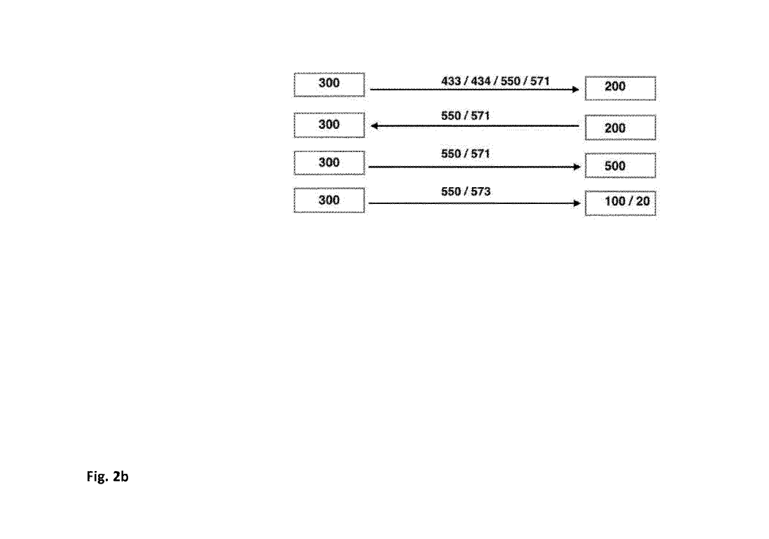

FIG. 2 shows an example of a schematic process flow of an embodiment of a method according to the invention with use of a wearable. FIG. 2a shows the associated communication flow for the schematic process flow shown in FIG. 2.

According to another embodiment of the method according to the invention it may be provided that by means of a user interface at the portal side data for the use of a wearable according to an input screen “wearable” (440) and/or a device interface (21) are queried from the receiver of knowledge (100) and a dataset wearable (570) is created e.g. with the following data:
type of device,
smartwatch
smartphone
ring
bracelet
clothing
device interface.

According to another embodiment of the method according to the invention it may be provided that by use of a device interface (21) at the portal side data (572) for the use of a wearable (20) are queried from the receiver of knowledge (100) and/or the wearable (20) and a data set “wearable” (571) e.g. with the following data is created:
data read from the device;
acoustic signals;
motion frequencies;
posture data (straight, oblique, etc.),
GPS data (e.g. location, traffic jam, bad weather)
biosensors: for example: temperature sensor, plentismograph.

Taking into account the information stored in the system the data are analyzed and evaluated, optionally stored in the data set (571), and by means of a device interface (21) data (573) are transmitted to a wearable (20) and/or a receiver of knowledge (100).

According to the invention it may be provided that the data exchange between a wearable (20) and the system (300) is implemented via an interactive device interface (21).

According to another embodiment of the method according to the invention it may be provided that the motion data wearable (571) and/or the skills catalogue (550) of a receiver of knowledge (100) are transmitted to an imparter of knowledge (200) for evaluation. After completion of evaluation and update of the data sets (550, 573) the system (300) transmits the data sets (550) and (573) e.g. with the following data:
data which are transmitted to the device;
control information (vibration, start acoustic signal (mp3, clock rate, metronome));
notation material;
songs
   to the receiver of knowledge (100) and the wearable (20).

According to a further embodiment of the method according to the invention it may be provided that the motion data wearable (571), the play-along video recording (433) and/or the lesson recording (434) and the skills catalogue (550) of a receiver of knowledge (100) are transmitted to an imparter of knowledge (200) for evaluation. After completion of evaluation and update of the data sets (550, 573) the system (300) transmits the data sets (550) and (573) to the receiver of knowledge (100) and the wearable (20).

FIG. 2b exemplarily shows the communication process flow preferably provided in such an embodiment.

According to a further embodiment of the invention the client (1000) and/or the client (3000) may be portable user terminals such as a smartphone, a tablet or a laptop.

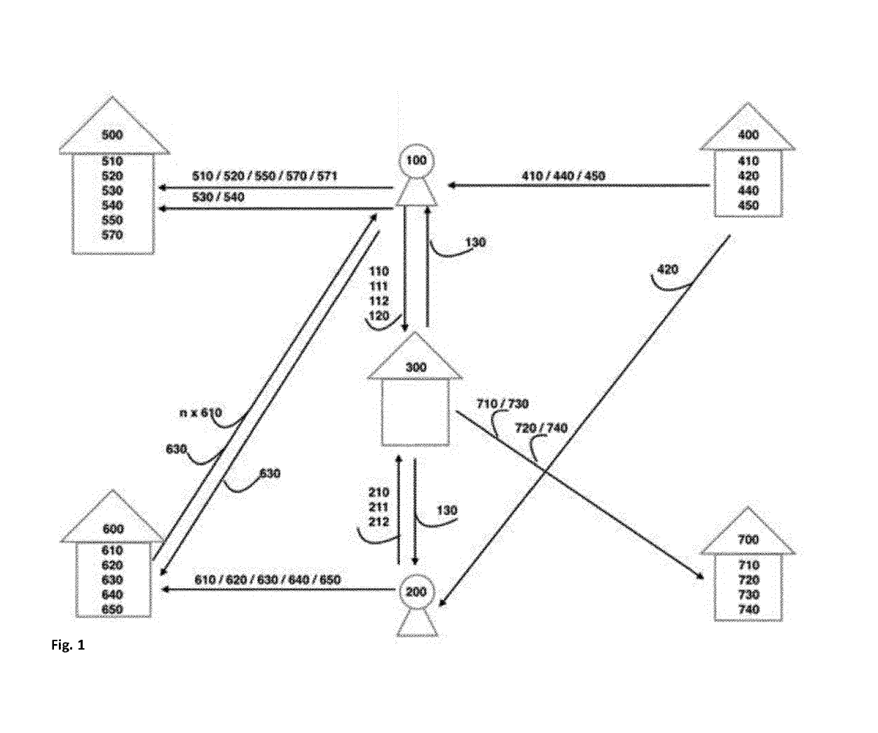

FIG. 1 shows an example of a schematic process flow of the method according to the invention.

A receiver of knowledge (100) logs on at a portal (300) by specifying a user ID (110) and a password (111). Herein, it may be provided that instead of a user ID (110) specific for the portal (300) third-party profile data (112) are used for identification. In connection with an initial registration of a receiver of knowledge (100) a master data set (510) is generated, which in addition to the user ID includes user-specific information such as
age;
music genre;
instrument;
feature “take group lessons”;
maximum/minimum group size;
feature “targeted search for imparter of knowledge”;
feature “targeted search for fellow musicians”;
feature “use of wearable”
   and comprises a skills catalogue (550) and #tags (520), which are queried at the portal side from the user during the initial registration by means of a user interface upon presentation of an assessment test (410). Similarly, an imparter of knowledge (200) logs on at the portal (300) by specifying a user ID (210) and a password (211). Herein, it may be provided that instead of a user ID (210) specific for the portal (300) third-party profile data (112) are used for identification. In connection with an initial registration of an imparter of knowledge (200) a master data set (610) is generated, which in addition to the user ID includes user-specific information such as
age;
music genre;
instrument;
tolerance times for compaction of dates or cancellation of lessons;
indicate other imparters of knowledge in case of cancellation of dates;
feature “give group lessons”;
maximum/minimum group size;
feature “give video feedback”.

According to a further preferred embodiment of the network-based system the server (2000) comprises a database system (2100) in which in addition to the template (2002) user information about a user of the client (1000) as well as a user of the client (3000) are stored.

According to a further preferred embodiment of the network-based system the client (1000) and the client (3000) each include a user interface (1005, 3005) by means of which user information is transmitted from a user of the client (1000) or of the client (3000) to the server (2000).

According to a further preferred embodiment of the network-based system the means (1006, 1007, 3002, 3003) comprises means for processing the audio and/or video signals (1012, 1013, 3016, 3017).

Moreover, the invention provides a method for imparting knowledge content between a receiver of knowledge and an imparter of knowledge by use of a system according to the invention.

A requirements catalogue (650) and #tags (620) etc. are queried during the initial registration by means of a user interface from the user at the portal side upon presentation of an assessment test (420).

For the selection of imparters of knowledge (200) suitable for the receiver of knowledge (100) taking into account information from a database (500) stored in the system, data from a master data set (510) (e.g. instrument), the skills catalogue (550) and #tags (520) and/or by use of the parameter “feature specific search for an imparter of knowledge” data from the master data set (510) are collated with the data in the database (600) from the master data set (610), requirements catalogue (650) and #tags (620) of the imparters of knowledge (200), sorted at the system side with respect to the greatest degree of match and displayed for the receiver of knowledge (100) at the portal side by means of a user interface.

In another embodiment of the method according to the invention it may be provided that by means of a user interface the selection of one of the displayed imparters of knowledge (200) is queried from the receiver of knowledge (100) at the portal side and under consideration of the information stored in the system data in the database (600) from the master data set (610), requirements catalogue (650) and #tags (620) (e.g. lesson calendar, #tag and information texts, profile image) are displayed for the receiver of knowledge (100) at the portal side on his terminal by means of a user interface.

In another embodiment of the method according to the invention it may be provided that the available dates (630) of the imparter of knowledge (200) are displayed for the receiver of knowledge (100) at the portal side by means of a user interface. In the course of displaying it may be provided to display those booking units among the tolerance times set by the imparter of knowledge (200) in an emphasized manner taking into account the information stored in the system which lead to benefits for the receiver of knowledge (100) (e.g. price reductions, points for free hours, etc.) and lead to an optimum/maximum capacity/compaction of the offered lessons for the imparter of knowledge (200). The bookings (120) selected by the receiver of knowledge (100) from the offered lessons are communicated to the system via user interfaces. The system by means of a new arrangement/modifications of the data sets lesson calendar (530) and lesson calendar (630), booked unit (540) and booked unit (640), billing set (720) and billing set (740) generates an update in the databases (500, 600, 700) and a booking confirmation (130) that is displayed at the portal side for the receiver of knowledge (100) and the imparter of knowledge (200) by means of a user interface on their terminals.

In another embodiment of the method according to the invention it may be provided that the receiver of knowledge (100) transmits a desired booking date to the system by means of a user interface. Taking into account the information stored in the system (300) the system selects the appropriate imparters of knowledge (210), which can service the desired date and are displayed at the portal side for the receiver of knowledge (100) by means of a user interface.

In another embodiment of the method according to the invention it may be provided that by means of a user interface the receiver of knowledge (100) transmits a booked unit (540) to the system (300) for cancellation. When the set tolerance time from the master data (610) is undercut the system (300) cancels the date by means of changes in the data sets lesson calendar (530) and lesson calendar (630), booked unit (540) and booked unit (640). If the set tolerance time from the master data (610) is not undercut, the billing data sets (720, 740) are cancelled. Preferably, the system (300) generates a cancellation confirmation (135) and the available dates (630) of the imparter of knowledge (200) for the receiver of knowledge (100). Likewise, a cancellation confirmation (135) for the imparter of knowledge (200) may be generated. The data are displayed at the portal side by means of a user interface on their terminals.

In another embodiment of the method according to the invention it may be provided that by means of a user interface the imparter of knowledge (200) transmits a booked unit (640) to the system (300) for cancellation. By means of a user interface the lesson calendar (630) with available alternate dates of the imparter of knowledge (200) is displayed at the portal side for the receiver of knowledge (100) on his terminal. By detecting 1. alternate date or 2. “cancel booking” on the terminal of the receiver of knowledge (100) the following steps are carried out at the portal side (300): 1. new arrangement/changes in the data sets lesson calendar (530) and lesson calendar (630), booked unit (540) and booked unit (640), billing set (720) and billing set (740), update of the databases (500, 600, 700) and generating a new booking confirmation which is displayed at the portal side for the receiver of knowledge (100) and the imparter of knowledge (200) by means of a user interface on their terminals; or 2. delete booked unit (540) and booked unit (640), billing set (720) and billing set (740) and change data sets lesson calendar (530) and lesson calendar (630). The cancellation confirmations (135) for the receiver of knowledge (100) and the imparter of knowledge 200 are displayed at the portal side by means of a user interface on their terminals.

In another embodiment of the method according to the invention it may be provided that by means of a user interface the imparter of knowledge (200) transmits booked units (640) for a period x to the system (300) for cancellation. The system searches the relevant receivers of knowledge (101) and displays at the portal side by means of a user interface the lesson calendar (630) with available alternate dates of the imparter of knowledge (200) for the receivers of knowledge (101) at their terminals. By detecting 1. alternate date or 2. “cancel booking” on the terminal of the receiver of knowledge (101) at the portal side (300) the following steps are carried out: 1. new arrangement/changes in the data sets lesson calendar (530) and lesson calendar (630), booked unit (540) and booked unit (640), billing set (720) and billing set (740), update of the databases (500, 600, 700) and generating a new booking confirmation, which is displayed at the portal side for the receivers of knowledge (101) and the imparter of knowledge (200) by means of a user interface on their terminals, or 2. cancellation of the booked unit (540) and the booked unit (640), billing set (720) and billing set (740) and changing the data sets lesson calendar (530) and lesson calendar (630). The cancellation confirmations (135) for the receiver of knowledge (100) and the imparter of knowledge (200) are displayed at the portal side by means of a user interface on their terminals. If the receiver of knowledge (100) and the imparter of knowledge (200) have selected the option “indicate another imparter of knowledge in the case of cancellation of date” other imparters of knowledge (201) will be displayed at the portal side for the relevant receivers of knowledge (101) by means of a user interface on their terminals. Then selection and process flow as for individual booking.

In another embodiment of the method according to the invention it may be provided that by means of a user interface the receiver of knowledge (100) at the time of booking (120) a lesson unit additionally transmits the information “take group lessons” to the system (300). If the imparter of knowledge (200) has set the feature “give group lessons” the system (300) searches for receivers of knowledge (101) with the feature “take group lessons” taking into account the information stored in a database (500), data from a master data set (510) (e.g. instrument), skills catalogue (550) and #tags (520) with the greatest degree of match/level correspondence with respect to the receiver of knowledge (100) and displays at the portal side the date by means of a user interface on their terminals. If the offer is not accepted within a time set by the system (300) the lesson unit is offered as a private lesson and displayed at the portal side for the receiver of knowledge (100) by means of a user interface on his terminal. Otherwise, the process flow may be carried out as in the case of an individual booking for each of the participating receivers of knowledge (101).

In another embodiment of the method according to the invention it may be provided that by means of a user interface the receiver of knowledge (100) in booking (120) a lesson unit additionally transmits the information “take group lessons” and the user ID of further receivers of knowledge (101) to the system (300). If the imparter of knowledge (200) has set the feature “give group lessons”, the system (300) by means of the transmitted user IDs searches for receivers of knowledge (101) with the feature “take group lessons” taking into account the information from a database (500) stored in the system and displays at the portal side the date by means of a user interface on their terminals. If the offer is not accepted within a time set by the system (300) the lesson unit is booked as a private lesson and displayed at the portal side for the receiver of knowledge (100) by means of a user interface on his terminal. Otherwise the process flow is the same as for an individual booking for each of the participating receivers of knowledge (101).

In another embodiment of the method according to the invention it may be provided that the receiver of knowledge (100) by means of a user interface transmits the search function “fellow musicians” to the system (300). For selecting receivers of knowledge (101) which are suited for the receiver of knowledge (100) taking into account the information from a database (500) stored in the system data are read out and collated, sorted at the system side according to the greatest degree of match (e.g. level, taste of music, spatial proximity, etc.) and displayed at the portal side for the receiver of knowledge (100) by means of a user interface.

In another embodiment of the method according to the invention it may be provided that by means of a user interface the receiver of knowledge (100) or the imparter of knowledge (200) transmits #tags (e.g. performers, styles, techniques, titles, etc.) to the system (300) for detection, modification or deletion. For this purpose the system creates or reads a data set #tag (520, 620) from the database (500, 600) for update. Taking into account the information stored in the system, the system creates links to e.g. booked lesson units (540, 640), bookings, etc.

According to one embodiment the method includes the following process steps:
a. registration of an imparter of knowledge by means of a user interface at the client (3000);
b. entering information on the qualification of the imparter of knowledge by means of a user interface at the client (3000);
c. transmitting the data obtained in steps a. and b. to the server (2000) and storing the data in a database system (2100) connected to the server (2000);
d. registration of a receiver of knowledge by means of a user interface at the client (1000);
e. entering information for the requirements of the receiver of knowledge to the imparter of knowledge;
f. transmitting the data obtained in steps d. and e. to the server (2000) and collating the data obtained in step e. with the information from step b. stored in the database system (2100);
g. transmitting the result of the collation carried out in step f. to the client (1000) and outputting the result via a user interface;
h. selecting an imparter of knowledge by the receiver of knowledge based on the result transmitted in step g. by means of a user interface;
i. notifying the imparter of knowledge selected in step h. about the selection made in step h. by means of a user interface;
j. transmitting information for implementing a knowledge-imparting exercise to the receiver of knowledge by the imparter of knowledge;
k. implementing a knowledge-imparting exercise by the receiver of knowledge based on the information transmitted in step j.;
l. transmitting signals detected in the implementation of the knowledge-imparting exercise by the means of detecting a motion, audio, and/or video signal (1001, 1002, 1003) to the server (2000) by means of the client (1000);
m. collating the signal(s) transmitted in step l. with a template of a signal suited for the knowledge-imparting exercise stored in the database system (2100);
n. transmitting the result of the collation in step m. to the client (2000) together with the signal detected by the means (1002, 1003) for detecting an audio and/or video signal (1012, 1013);
o. outputting the result transmitted in step n. and the signals via the means (3002) or (3003 and 3004).

In another embodiment of the method according to the invention it may be provided that an imparter of knowledge (200) during an interactive connection (lesson) with a receiver of knowledge (100) or by directly calling up the skills catalogue (550) of a receiver of knowledge (100) makes changes to the data elements (e.g. technique, performance, theory and practice, repertoire, etc.). To this end by taking into account the information on the active lesson session stored in the system or at request to the system (300) through imparters of knowledge (200) the data fields from the data elements skills catalogue (550) are displayed at the portal side by means of a user interface on his terminal.

The skills catalogue (550) includes user-related information, which in turn respectively depending on the degree of compliance (e.g. I know/I have to e.g. 0, 33, 66, or 100%) reflect the “degree of maturity” of the receiver of knowledge (100). Each of these data elements may have different numbers of accompanying levels. The structural depth of the skills catalogue (number of levels and contents per level) is adapted to the respective situation of the user (e.g. beginner, advanced, master). In each of the data elements of the last level the feature of the degree of compliance is indicated. Each data element independent of which level is displayed in addition to the name together with a symbol which according to the degree of compliance e.g. is filled with a color.

With respect to the data element “technique” the other levels of the data structure of the skills catalogue (550) are exemplarily illustrated. Data level 2 includes, for example, the data elements: play techniques, posture, coordination, tuning/pitch/sound etc. The data element play techniques has, for example, level 3 and can, for example, include the data elements: plectrum, bending, strumming pattern and so forth. The imparter of knowledge now, for example, has the option to click a value from a scale of values (e.g. 0, 33, 66 or 100%) stored with respect to the data element plectrum and, thus to assess and document the lessons progress of the receiver of knowledge 100. By means of the visual representation of the data structure an overview over the actual development of the receiver of knowledge (100) is obtained. By means of a user interface inputs of the imparter of knowledge are transmitted to the individual indicated data fields for storage.

According to a further embodiment of the method a step e′ is provided between steps e. and f. within which a receiver of knowledge enters information on existing qualifications in terms of the desired knowledge content by means of a user interface, these data are transmitted to the server (2000) and are stored in the connected database system (2100).

According to a further embodiment of the method it is provided that the template taken into account in the step m. is a play-along audio/video signal and single signal contents of the play-along signal can be selected and influenced by the receiver of knowledge by suitable means of a user interface of the client (1000).

### Comments on Play-Along:

Play-along is an interactive video in which the user adds a missing audio track/video track or plays along with an existing one. The receiver of knowledge views himself on the screen of his smartphone, laptop or tablet, captured by a camera (e.g. a webcam or a camera of the device) in real time. Recorded musicians displayed on the screen play together a piece of music, wherein the receiver of knowledge is shown, for example, in the middle, captured by his camera. He starts, interrupts and stops the video. At the same time he can control the playback speed. To this end the audio track of the video is appropriately pitched to the output sound. The receiver of knowledge can activate or deactivate or zoom in individual musician in the video (audio and video). Upon request, the played piece can be recorded and evaluated manually by an imparter of knowledge (see video feedback) or the system. The evaluation of the system is carried out by an analysis of various values of the audio and/or video recording in comparison with predetermined target values associated to the video. These recordings are stored in the database in association with the receiver of knowledge.

According to a further embodiment of the method it is provided that the play-along signal influenced by the receiver of knowledge by the appropriate means of the user interface is send back to the server (2000) together with a signal detected by the means of detecting an audio and/or video signal (1002, 1003) and is stored in the database system (2100) connected to the server (2000).

According to a further embodiment of the method it is provided that by means of the user interface at the client (1000) information about the type of influence of the play-along audio/video signal are entered and transmitted to the server (2000) and an influenced play-along audio/video signal is transmitted by the server to the client (1000).

According to a further embodiment of the method it is provided that based on the comparison made in step m. and/or an input made by the imparter of knowledge via a user interface changes of the information input in step e. and/or e′ are stored in the database system (2100) connected to the server (2000).

According to a further embodiment of the method it is provided that during step k. an audio and/or video signal (3016, 3017) of the imparter of knowledge is recorded by means of suitable means (3006, 3007) signally connected to the client (3000) and is transmitted via the packet-switched network to the client (1000) over the server (2000) and is output there by the means (1007, 1006).

In another embodiment of the method according to the invention it may be provided that by means of a user interface the receiver of knowledge (100) uploads recorded exercise sessions (video) (560) to the portal and transmits the value “video feedback” to the system (300). In consideration of the information stored in the system (300) the system selects the appropriate imparters of knowledge (210) which have set the feature “give video feedback”, which then are displayed for the receiver of knowledge (100) at the portal side by means of a user interface.

The receiver of knowledge (100) selects one imparter of knowledge (200) from the proposals. After selection or portal side assignment of an imparter of knowledge (200) the system (300) assigns recorded exercise sessions (video) (560) to the imparter of knowledge (200) for evaluation. The imparter of knowledge (200) gives a feedback through direct communication (via portal 300) and/or entries in the skills catalogue. The system (300) generates a billing set (720) and a billing set (740) and a booking confirmation (130) which are displayed at the portal side for the receiver of knowledge (100) and the imparter of knowledge (200) by means of a user interface on their terminals.

In another embodiment of the method according to the invention it may be provided that the system (300) taking into account the information on skills catalogue (550) and #tags (520) stored in the system proposes a play-along video (hereinafter PaV) (430) for the receiver of knowledge (100) by means of a user interface or the receiver of knowledge (100) retrieves a play-along video (430) from the system (300) by means of a user interface. The receiver of knowledge (100) transmits in a parameter set (432) (e.g. own role in the PaV (430), playback speed, recording of the own role during the playback of PaV, display/hide musicians, etc.) the settings for the execution of the play-along video (430) by means of a user interface. The system (300) establishes an interactive connection between the terminal of the receiver of knowledge (100) and the portal (300) and starts the PaV (430) taking into account the data from the parameter set (432). It may also be the case that the receiver of knowledge (100) transmits in a parameter set (432) (e.g. start/stop, playback speed, providing for video feedback to the imparter of knowledge (200), etc.) further settings for controlling the play-along video (430) to the system (300) by means of a user interface.

In another embodiment of the method according to the invention it may be provided that by means of a user interface data (433) detected by an external device (PaV recording audio/video) are transmitted from the receiver of knowledge (100) to the system (300) for analysis/evaluation/storage.

Likewise, a signal generated by a signal generating unit (e.g., instrument, sound box, user movements, etc.) can be transmitted through the transmitting unit (20) as a data set (570) to the system (300) by means of a device interface. Taking into account the information stored in the system the data are analyzed and evaluated, optionally stored in the data set (810) and data (571) are transmitted to the unit/terminal by means of a device interface. According to the invention it may be provided that the data exchange between the unit (20) and the system (300) is implemented via an interactive device interface.

According to a further embodiment of the method it is provided that the audio and/or video signal (3016, 3017) of the imparter of knowledge transmitted to the client (1000) and output there by the means (1006, 1007) is analyzed by suitable means of the server (2000) and collated to a template (2003) stored in a database system (2100) connected to the server (2000).

Thus, a network-based method for imparting knowledge is provided, which may comprise the following steps:
acquire inputs of master data at the input system of the receiver of knowledge;
input master data by the receiver of knowledge;
provide data from third-party profile data of the receiver of knowledge, if any;
supplement master data of the receiver of knowledge;
store master data in database of the receiver of knowledge;
acquire input of master data at the input system of the imparter of knowledge;
input master data by the imparter of knowledge;
provide data from third-party profile data of the imparter of knowledge, if any,
supplement master data of the imparter of knowledge;
store master data in database of the imparter of knowledge;
acquire information of assessment test by input at the terminal of the receiver of knowledge with respect to
   technical knowledge;
   theoretical knowledge;
   implementation of knowledge;
   preference of field of knowledge;
store in master data set, skills catalogue and #tags in database of the receiver of knowledge;
acquire information of requirements catalogue by input at the terminal of the imparter of knowledge with respect to
   technical knowledge;
   theoretical knowledge;
   implementation of knowledge;
   preference of field of knowledge;
store in master data set, requirements catalogue and #tags in database of the imparter of knowledge;
select and transmit imparter of knowledge through portal at the terminal of the receiver of knowledge;
matching of master data, skills catalogue and #tags of receiver of knowledge with master data, requirements catalogue and #tags of database of imparter of knowledge;
transmit data sets of the imparter of knowledge with the highest degree of match to the terminal of the receiver of knowledge;
select an imparter of knowledge by the receiver of knowledge at the terminal of the receiver of knowledge;
select an imparter of knowledge from the matched imparters of knowledge;
read data of the imparter of knowledge from the database of the imparter of knowledge;
transmission to the terminal of the receiver of knowledge;
selection by receiver of knowledge;
selection and booking of time units by receiver of knowledge;
read out all time units from database of the imparter of knowledge;
display available time units in the booking window of the imparter of knowledge and the time units which lead to the highest compaction of the booking time period;
select one or more time units by the receiver of knowledge;
input #tags related to the lessons;
input personal messages for the imparter of knowledge;
acquire a check-out message of the receiver of knowledge by means of which the completion of his booking is indicated in the knowledge transfer platform;
store the data with respect to lessons (times, #tags, messages) in the database of the receiver of knowledge and the imparter of knowledge;
create booking data sets for the receiver of knowledge and the imparter of knowledge;
store booking data sets in the database of the receiver of knowledge and the imparter of knowledge for;
   billing purposes in the billing database;
   marking booked time units;
   confirming booked time units;
cancelling time units by the receiver of knowledge;
   collate the time unit to be cancelled with the tolerance value from the data set of the imparter of knowledge;
   propose new units of time if within the time tolerance, otherwise calculation of the booked time unit of the receiver of knowledge;
cancelling time units by imparter of knowledge;
   propose new time units for the receiver of knowledge;
   acception by the receiver of knowledge or refund of the booked time unit to the receiver of knowledge;
cancel time units for a time period X by the imparter of knowledge;
   display alternative time units; or
   display available time units of other imparters of knowledge which correspond to the parameters of the receiver of knowledge for selecting imparters of knowledge;
for all cancellations listed above applies:
   detect a check-out message of the receiver of knowledge, by means of which the completion of his booking is indicated at the knowledge transfer platform;
store the data with respect to lessons (times, #tags, massages) in the database of the receiver of knowledge and the imparter of knowledge
create booking data sets for the receiver of knowledge and the imparter of knowledge;
store booking data sets in the database of the receiver of knowledge and the imparter of knowledge with respect to;
   billing purposes in the billing database;
   indication of booked time units;
   confirmation of booked time units.

Features teaching procedure
algorithm determination of pending lessons in database;
notify receiver of knowledge and imparter of knowledge of start of lesson;
establish video session;
record lesson log
   marker for positioning information on a timeline;
   create photo from video stream of imparter of knowledge;
   record lesson video;
   text messages;
   skills catalogue;
   teaching material;
   #tags;
   system messages;
lesson start/end;
   establishment/termination of connection of receiver of knowledge and imparter of knowledge.

Display lesson log
marker positioning;
text messages;
skills catalogue;
change skills catalogue by imparter of knowledge;
photo from video stream of imparter of knowledge;
teaching material;
#tags;
system messages;
lesson start/end;
establishment/termination of connection of receiver of knowledge and imparter of knowledge;
store lesson log in database of receiver of knowledge;
   store lesson video, photo from video stream of imparter of knowledge, marker positions including information about marker, text messages, skills catalogue, #tags, system messages, teaching material;
initiate payment process and create/store statistics data;
read skills catalogue from database of receiver of knowledge and display on terminal of receiver of knowledge and imparter of knowledge;
   display data elements level 1;
   display data elements level 2;
   display data elements level 3;
   display data elements level 4;
   display data elements level n;
   display scale of values for data elements, if any;
   change scale of values according to knowledge of receiver of knowledge by imparter of knowledge;
acquire and store #tags from different process steps in database of receiver of knowledge;
   lesson;
   profile display;
added values of the portal due to data mining
   detect algorithm parameters at the terminal of the receiver of knowledge;
   algorithm database of receiver of knowledge and imparter of knowledge;
   learning support via app;
   display at terminal of receiver of knowledge;
   profiles imparters of knowledge using specific requirements/targets;
   profiles imparters of knowledge after data modification or initial registration in the portal;
   profiles receivers of knowledge for receivers of knowledge using specific requirements/targets;
e.g. same level, geographical proximity, same genre, particular instrument
   profiles receivers of knowledge for the receivers of knowledge for the purpose of group lessons;
   play-along video recordings for social media and profile;
video feedback
   video recording of receiver of knowledge;
   store recorded videos in database of receiver of knowledge;
   select imparters of knowledge from database of imparters of knowledge which have set the corresponding feature “video evaluation” for evaluating videos of the receiver of knowledge;
   notify imparter of knowledge and provide the video;
   evaluation in skills catalogue of the receiver of knowledge by the imparter of knowledge;
   feedback to receiver of knowledge by
      video message;
      text message;
   optionally payment process, if it is a fee-based service of the imparter of knowledge;
   use of portal functionalities by the receiver of knowledge such as skills catalogue, #tags and store own videos for organization and documentation of autonomous learning;
video with musicians/play along
   use of portal functions such as skills catalogue and #tags for suitable offer of a play-along video for receiver of knowledge. Receiver of knowledge sees himself live recorded by a camera (e.g. webcam, smartphone camera) as missing voice displayed in a band on the terminal of the receiver of knowledge and makes music as a fellow musician;
   store the recording and evaluation by imparter of knowledge and/or system;
group lessons
   use of portal functions such as skills catalogue, requirements catalogue and #tags for group lessons of receivers of knowledge similar, for example, in level and/or taste with imparter of knowledge for the purpose of group lessons in video chat;
   booking processing as described for individual lessons, however:
   algorithm parameters group lessons in database of receiver of knowledge;
   notification of the determined receivers of knowledge;
   acception of the proposed time units by receivers of knowledge until the group strength predetermined by the imparter of knowledge is reached; or
   booking processings as described for individual lessons, however:
   entering receivers of knowledge for group lessons at the terminal of receiver of knowledge;
   notification of the receivers of knowledge;
   acception of the proposed time units by receivers of knowledge;
use of wearables
   acquire audio, video, bio, and motion signals of receiver of knowledge;
   evaluation by system template:
   for example, matching predetermined deviation values of the audio signal, for example, with respect to concert pitch A;
   for example, matching deviation values with respect to rhythmic defaults;
evaluation by imparter of knowledge;
feedback to receiver of knowledge.

### Example of a Play-Along

Objectively: Video play-alongs allow a musician a playful and authentic learning of songs by playing a “missing track” of a song with his instrument together with a band (on the screen).

Emotionally: By means of play-alongs the user has in an easy and convenient way the opportunity to be part of a band, maybe even of his favorite band. By use of laptop, smartphone or tablet he can, no matter where he is, “go into the rehearsal room with the band” and thus comes as close to the musician as never before. What could be closer than to make music together with one's favorite band?

Technically: Comparable to “band-karaoke”—the difference here is that the user has the opportunity not only to remove the vocal track from the song and sing to the song, but each (used) instrument of a produced play-alongs can be switched on and off, so that one becomes part of the band with one's instrument, clicking on a musician gives an insight into the technique and the notes of his play (tutorial level).

### Example of a User-Flow:

Let's start with an example: The user is guitarist and acquires a play-along of band X. He sees band X in the rehearsal room or in the studio. He sees every musician of the band and himself on the screen respectively in a separate small window. A small navigation area enables the user to adjust things (volume, click-track etc.), the most important here is: the user decides himself, which musician/instrument he wants to see and hear. He decides only to switch off the guitar track. The sound track of the guitarist is removed and he can take over the guitar in his place (of course, even more than one track can be switched off—at least one track should be visible in addition to his track). And here we go . . . the singer counts in and plays together with the band on his device, for example in his living room.

Now two phases begin.

1. Play-along level: He plays together with the band. He switches musicians on and off. Keyword:

2. Tutorial Level: just a click in a user interface, for example on “detail view” the user sees exactly how and what is played.

Situation 1: He has never played the song.

He clicks away all the other musicians excluding the guitar and listens exactly what the guitarist plays. By click on “detailed view” he sees in more detail what he grips, how he strikes or plucks, and what his technique is.

Situation 2: The user is familiar with the notes and chords, but he wants to learn to play it correctly. He leaves all musicians (including the guitarist) switched on and plays together with the band. A record of the played-along song lets him check afterwards how good he really was.

Situation 3: The user has himself grooved in and is quite sure.

He clicks the track of the guitarist off and plays the song on its own with the rest of the band.

Situation 4: The user has extensive skills.

The user plays his own interpretation on the guitar only with the singer so good that he wants to share it on social media (e.g. Facebook, YouTube)! (Of course, it is possible to share any situation—as long as he wants it as a user)

### LIST OF REFERENCE NUMBERS

10 terminal (PC, tablet, all devices that display information)
20 wearable
21 device interface wearable
100 receiver of knowledge/terminal receiver of knowledge
101 further receivers of knowledge
110 user ID
111 password
112 third-party's profile data
120 booking lesson unit
130 confirmation booking lesson units
135 cancellation
150 recording exercise units/play-along
180 check out
190 further receivers of knowledge
200 imparter of knowledge/terminal imparter of knowledge
201 further imparters of knowledge
210 input ID
211 password
212 third-party's profile data
300 portal/system
310 confirmation booked units receiver of knowledge
320 confirmation booked units imparter of knowledge
400 database admin
410 assessment test dummy receiver of knowledge
420 assessment test dummy imparter of knowledge
430 play-along video
432 parameter set PaV
433 play-along video recording audio/video
434 lesson recording audio/video
440 entry screen master data wearable
450 entry screen motion data wearable
500 database receiver of knowledge
510 master data receiver of knowledge
520 #tag
530 lesson calendar receiver of knowledge
540 booked units receiver of knowledge
550 skills catalogue
560 recording exercise units/play-along
570 master data wearable
571 motion data wearable
572 data from wearable
573 data to wearable
600 database imparter of knowledge
610 master data imparter of knowledge
620 #tag
630 lesson calendar imparter of knowledge
640 booked units imparter of knowledge
650 requirements catalogue
700 database billing
710 billing account receiver of knowledge
720 billing set receiver of knowledge
730 billing account imparter of knowledge
740 billing set imparter of knowledge
800 database wearable
1000 first client
1001 input means motion signal
1002 input means audio signal
1003 input means video signal
1004 not used
1005 user interface first client
1006 output means audio signal
1007 output means video signal
1011 motion signal
1012 audio signal
1013 video Signal
2000 server
2002 template
2003 template second imparter of knowledge
2100 database system
3000 second client
3002 output means audio signal
3003 output means video signal
3004 output means analysis signal
3005 user interface second client
3006 input means audio signal
3007 input means video signal
3016 audio signal
3017 video signal
4000 analysis signal

1. A network-based system for imparting knowledge content, comprising:
a first client;
a server,
a second client wherein the first client and the second client are communicatively connected to the server via a packet-switched network system;
means for detecting a motion, audio, and/or video signal, wherein the means is signally connected to the first client;
means for outputting an audio and/or video signal, wherein the means is signally connected to the first client;
means for outputting an audio and/or video signal, wherein the means is signally connected to the second client;
means for outputting an analysis signal, wherein the means is signally connected to the second client;
wherein
the server is configured to receive information on a motion, audio and/or video signal detected by the means via the packet-switched network from the first client, collate the detected signal with a template stored in a data base system connected to the server and transmit the received motion, audio and/or video signal together with information on the deviation of the received signal from the stored template as an analysis signal to the second client via a packet-switched network, wherein the second client is configured to output the audio and/or video signal received from the server via means together with the analysis signal via means.

2. The network-based system according to claim 1, wherein the means for detecting a motion signal is a device which may be attached to a human body or to a means operated by the human body which comprises at least one inertial sensor and a communication interface for transmitting inertial sensor signals to the first client.

3. The network-based system according to claim 1, wherein the server comprises a database system, in which in addition to the template user information on a user of the client and a user of the client is stored.

4. The network-based system according to claim 1, wherein the client and the client each comprise a user interface by means of which user information can be transmitted from a user of the client or the client to the server.

5. The network-based system according to claim 1, wherein the means comprises means for processing the audio and/or video signal.

6. A method for imparting knowledge contents between a receiver of knowledge and an imparter of knowledge by use of a system according to claim 1.

7. The method according to claim 6, comprising the steps of:
a. registration of an imparter of knowledge via a user interface at the client;
b. entering information about the qualifications of the imparter of knowledge via a user interface at the client;
c. transmitting the data obtained in steps a. and b. to the server and storing the data in a database system connected to the server;
d. registration of a receiver of knowledge by means of a user interface at the client;
e. entering information on requirements of the receiver of knowledge to the imparter of knowledge;
f. transmitting the data obtained in steps d. and e. to the server and the collating the data obtained in step e. with information of step b. stored in the data base system;
g. transmitting the result of the collation carried out in step f. to the client and outputting the result via a user interface;
h. selecting an imparter of knowledge by the receiver of knowledge based on the result transmitted in step g. by means of a user interface;
i. notifying the imparter of knowledge selected in step h. of the decision made in step h. by means of a user interface;
j. transmitting information on the implementation of a knowledge-imparting exercise to the receiver of knowledge by the imparter of knowledge;
k. implementing a knowledge-imparting exercise by the receiver of knowledge based on the information transmitted in step j.;
l. transmitting signals detected in the implementation of the knowledge-imparting exercise by the means of detecting a motion, audio, and/or video signal to the server by means of the client;
m. collating the signal(s) transmitted in step l. with a template of a signal appropriate for a knowledge-imparting exercise stored in the database system;
n. transmitting the result of the collation in step m. to the client together with the signal detected by the means for detecting an audio and/or video signal;
o. outputting the result transmitted in step n. and the signals via the means or.

8. The method according to any claim 6, wherein between steps e. and f. a step e′ is provided, in which a receiver of knowledge enters information on existing skills in terms of the desired knowledge content by means of a user interface, these data are transmitted to the server and are stored in the connected database system.

9. The method according to claim 6, wherein the template taken into account in step m. is a play-along audio/video signal and individual signal contents of the play-along signal can be selected and influenced by the receiver of knowledge by suitable means of a user interface of the client.

10. The method according to claim 9, wherein the play-along signal influenced by the receiver of knowledge by suitable means of the user interface is transmitted back to the server together with a signal detected by the means for detecting an audio and/or video signal and then is stored in the database system connected to the Server.

11. The method according to claim 9, wherein by means of the user interface at the client information about the kind of influence of the play-along audio/video signal is entered and transmitted to the server and an influenced play-along audio/video signal is transmitted to the client by the server.

12. The method according to claim 6, wherein based on the collation carried out in step m. and/or based on an input made by the imparter of knowledge by means of a user interface changes to the information entered in step e. and/or e′ are stored in the database system connected to the server.

13. The method according to claim 6, wherein during step k. an audio and/or video signal of the imparter of knowledge is recorded by appropriate means which are signally connected to the client and is transmitted by the server via the packet-switching network to the client and is there outputted by the means.

14. The method according to claim 13, wherein the audio and/or video signal of the imparter of knowledge transmitted to the client and outputted there by the means, is analyzed by suitable means of the server and is collated with a template stored in a database system connected to the server.
